(19) United States
(12) Patent Application Publication
(10) Pub. No.: US 2005/0172736 A1
(43) Pub. Date: Aug. 11, 2005

(54) Thickness detection device for filling and packaging bag

(76) Inventors: Masaki Kumagai, Niigata (JP); Toshiaki Nagasawa, Niigata (JP)

Correspondence Address: MCDERMOTT WILL & EMERY LLP, 600 13TH STREET, N.W., WASHINGTON, DC, 20005-3096, US

(21) Appl. No.: 10/516,112

(22) PCT Filed: Mar. 31, 2003
(86) PCT No.: PCT/JP03/04150

(30) Foreign Application Priority Data
May 31, 2002 (JP) 2002-159494
Mar. 27, 2003 (JP) 2003-87133

(51) Int. Cl. G01B 5/06

(52) U.S. Cl. 73/865.8; 53/507

(57) ABSTRACT

A thickness detection device for filling and packaging bag, comprising a thickness detection mechanism capable of detecting a difference in thickness between a bag-shaped part and a lateral seal part formed in a continuous filling and packaging bag having detection elements following up the lateral movement of the filling and packaging bag relative to the feeding direction of the continuous filling and packaging bag positioned so as to be allowed to pressingly abut on each other from both outer surface sides of the film of the filling and packaging bag and a detector for detecting the displacement of the detecting elements by a difference in thickness between the bag-shaped part and the lateral seal part of the filling and packaging bag, whereby even if a packaging style for each package type, particularly, the thickness of the filling and packaging bag is changed, the follow-up capability to the lateral movement for the filling and packaging bag can be improved, and the detector can be operated in stable condition without being affected by a variation in thickness of the bag-shaped part of the filing and packaging bag.

### TECHNICAL FIELD

This invention relates to a thickness detection device for a filling and packaging bag for detecting the thickness of the filling and packaging bag while the continuous filling and packaging bag accommodating content such as liquid or powder is being transferred.

### BACKGROUND ART

In filling and packaging bags in general that store content such as liquid or powder, a filling and packaging machine continuously feeds a belt-like film, forms a longitudinal seal portion heat sealed in a longitudinal direction and transverse seal portions heat sealed with predetermined intervals in a transverse direction with respect to the longitudinal direction while bags are being made, and forms bag portions for filling the content into the film encompassed by the longitudinal seal portion and the transverse seal portions. The filling and packaging bags into which the content is filled and which are sealed are cut at the center of the transverse seal portion of each filling and packaging bag by a cutter mechanism provided to the filling and packaging machine into individual small bags. Alternatively, the filling and packaging bag is delivered while perforation is formed at the center of the transverse seal portion, or the filling and packaging bag in the continuously connected form is delivered into an automatic packaging apparatus provide to a next step so that a thickness detection mechanism for a filling and packaging bag, provided to the automatic packaging apparatus counts a predetermined number of filling and packaging bags and packages them into a box.

In this case, the thickness detection mechanism counts a predetermined number of filling and packaging bag continuously connected and the bags are then packaged into the box while being folded, or the thickness detection mechanism detects the transverse seal position of the filling and packaging bag, cuts the filling and packaging bag into individual bags by a cutter mechanism provided to the packaging apparatus while a predetermined number of bags is counted, and accommodates the individual filling and packaging bags so cut into the box.

When the content is foodstuffs, the filling and packaging bags are generally subjected to heat treatment at a high temperature for sterilization either before or after the packaging operation from the hygienic aspect. In this instance, the content is likely to get denatured when left under the heated state and the packaging and filling bags under the high temperature state cannot be easily packaged in succeeding steps such as the packaging step.

Therefore, a proposal has been made that feeds the filling and packaging bags cut off by the cutter mechanism of the filing and packaging machine into a net conveyor provided to a cooling apparatus having a water tank, for example, through a conveyor, transfers the filling and packaging bags inside the cooling medium of the cooling apparatus to rapidly cool them and thereafter delivers them outside the cooling apparatus by a delivery conveyor. However, the construction of the system becomes great in scale because of the cooling apparatus having the conveyor and the net conveyor and the delivery conveyor. In addition, because the bags are the packaging bags cut into the individual bags, a removing operation of the cooling medium adhering to the packaging bags cannot be carried out easily and efficiently.

As means for solving the problem, it has been customary to deliver the continuous belt-like filling and packaging bag to the cooling apparatus without cutting it by the cutter mechanism provided to the filling and packaging machine, to transfer the bag inside the cooling apparatus to cool the content, and to cut the continuous belt-like packaging bag after the cooling treatment into individual or a plurality of continuous filling and packaging bags by the cutting device installed as a post step to the cooling apparatus.

The cutting device described above includes a transfer mechanism having a pair of delivery rollers or a pair of delivery belts for supplying the continuous belt-like filling and packaging bag which is formed into the bag shape and into which the content is filled and packaged by the filling and packaging machine to the feed side of the cutting device installed as the post step, a detection mechanism having a pair of thickness detection rollers for detecting a change of thickness between a bag portion and a transverse seal portion of the continuous belt-like packaging bag so transferred and a cutter mechanism, and operates a cutter of the cutter mechanism in such a fashion as to cut the center portion of the transverse seal portion of the continuous belt-like packaging bag in accordance with the distance from the detection position to the cutter mechanism on the basis of the detection signal of the detection mechanism and to obtain individual or a plurality of continuous packaging bags.

To count the number of filling and packaging bags or to detect the cutting position of the transverse seal portion between the filling and packaging bags in the automatic packaging apparatus and the cutter device according to the prior art technology described above, Japanese Utility Model Laid-Open No. 26322/1983 or No. 16168/2002 proposes a thickness detection device for detecting a change of thickness of a continuous belt-like filling and packaging bag, that is, for detecting a difference in thickness between a transverse seal portion as a reduced thickness portion and a bag portion as a thick portion into which content is filled and sealed, including a pair of thickness detection rollers such as fixed rollers capable of rotation and rocking rollers so arranged as to face the fixed roller and rocking rollers so disposed as to face the fixed rollers and to push the fixed rollers by spring force or attraction/repulsive force of a magnet. This detection device picks up the difference in thickness as displacement of the rocking rollers and detects the excess of this displacement amount beyond a predetermined value by a detector to detect the thickness of the filling and packaging bag.

However, the prior art apparatus described above detects the difference in thickness between the transverse seal portion as the reduced thickness portion and the bag portion as the thick portion storing the content as the displacement of the rocking rollers as described above. The swell of the bag portion is small when the amount of the content stored in the bag portion is small and the displacement of the rocking rollers is small and the swell portion of the bag portion is great when the content stored in the bag is great and the displacement of the rocking rollers becomes great, on the contrary. Therefore, adjustment must be made in match with the displacement of the rocking rollers. When the continuous belt-like filling and packaging bag is detected while being transferred at a high speed, the filling and packaging bag is likely to undergo rolling due to resonance with respect to the feed of the continuous filling and packaging bag and rocking of the rocking rollers cannot follow in some cases the change of the shape of the filling and packaging bag. In this case, chattering is more likely to occur as the displacement of the rocking rollers becomes greater.

To solve the problems of the prior art, the invention aims at providing a thickness detection device for a filling and packaging bag that can correctly detect the boundary of thickness between the bag portion and the transverse seal portion of the filling and packaging bag and can stably conduct the follow-up operation without being affected by the amount of the content such as liquid or powder stored in the bag portion of the filling and packaging bag.

### DISCLOSURE OF THE INVENTION

A thickness detection device for a filling and packaging bag according to the invention includes a transfer mechanism for transferring a filling and packaging bag having bag portions formed by filling and accommodating a content into a film encompassed by a longitudinal seal portion and transverse seal portions under a continuous state; and a thickness detection mechanism capable of detecting a difference in thickness between the bag portion and the transverse seal portion formed in the continuous filling and packaging bag; wherein the thickness detection mechanism includes detection elements capable of following rocking of the filling and packaging bag in a transverse direction with respect to a feeding direction of the continuous filling and packaging bag, facing each other from both outer surface sides of the film of the filling and packaging bag and capable of pushing, and coming into contact with, each other, and a detector for detecting displacement of the detection elements resulting from the difference in thickness of the bag portion and the transverse seal portion of the filling and packaging bag. Therefore, even when a package form for each kind of a product, particularly a thickness of the filling and packaging bag, changes, follow-up performance for rolling of the filling and packaging bag becomes excellent and the detector can be operated under a stable state without being affected by the change of the thickness of the bag portion of the filling and packaging bag.

The invention provides also a thickness detection device for a filling and packaging bag including a transfer mechanism for transferring a filling and packaging bag having bag portions formed by filling and accommodating a content into a film encompassed by a longitudinal seal portion and transverse seal portions under a continuous state; and a thickness detection mechanism capable of detecting a difference in thickness between the bag portion and packaging bag and the transverse seal portion formed in the continuous filling; wherein the thickness detection mechanism includes detection elements facing each other from both outer surface sides of the film of the filling and packaging bag and capable of pushing, and coming into contact with, each other, support members for respectively supporting the detection elements in such a fashion as to be capable of rocking with a support shaft as a base point, and a detector for detecting displacement of the detection elements arranged at a predetermined position of the support members. Therefore, even when a package form for each kind of a product, particularly a thickness of the filling and packaging bag, changes, follow-up performance for rolling of the filling and packaging bag becomes excellent because the detection elements facing each other from both outer surface sides of the film of the filling and packaging bag and capable of pushing, and coming into contact with, each other are provided to the support members in such a fashion as to be capable of rocking with a support shaft as a base point, and the detector can be operated under a stable state without being affected by the change of the thickness of the bag portion of the filling and packaging bag.

In this instance, an elastic member is interposed between the support members of the thickness detection mechanism so that the detection elements face each other from both outer surface sides of the film of the filling and packaging bag and can push, and come into contact with, each other. The detection elements are arranged in such a fashion as to clamp and push the filling and packaging bag from both outer surfaces of the bag portion of the filling and packaging bag by the tension of the elastic member and the thickness detection mechanism conducts the follow-up operation from both sides in response to the difference in thickness between the swell portion of the bag portion and the reduced thickness portion of the transverse seal portion. Consequently, even when the transfer speed of transferring at a high speed the filling and packaging bag under the continuous state becomes high, response becomes higher than before and detection accuracy can be improved.

The thickness detection device further includes a guide and support mechanism for guiding the filling and packaging bag transferred by the transfer mechanism, capable of clamping and holding the bag portion of the filling and packaging bag from both sides, and the guide and support mechanism is arranged adjacent to the thickness detection mechanism. Therefore, even when the detection elements facing each other from both outer surface sides of the film of the filling and packaging bag and capable of pushing, and coming into contact with, each other push the bag portion of the filling and packaging bag, the guide and support mechanism clamps from both sides the bag portion of the filling and packaging bag. Therefore, when the content is liquid, for example, the detection elements can detect the bag portion under the solid swell state and can clarify the change component of thickness between the position of the bag portion and the position of the transverse seal portion.

### BRIEF DESCRIPTION OF THE DRAWINGS

FIG. 1 is a schematic view showing an overall construction when a thickness detection device for a filling and packaging bag according to a first embodiment is applied to a packaging system.

FIG. 2 is a schematic perspective view showing packaging bags until continuous belt-like filling and packaging bag applied in the first embodiment is formed.

FIG. 3 is a schematic perspective view showing main portions of a thickness detection device provided to a cutting device shown in FIG. 1.

FIG. 4 is a front view of main portions and primarily shows a thickness detection mechanism of a filling and packaging bag in a cutting device shown in FIG. 3.

FIG. 5 is a front view of main portions and shows an operation of the thickness detection mechanism of the filling and packaging bag shown in FIG. 4.

FIG. 6 is a front view of main portions of a guide and support mechanism under an operating condition corresponding to FIG. 5.

FIG. 7 is a front view of main portions and primarily shows a thickness detection mechanism of a filling and packaging bag provided to a cutting device according to a second embodiment.

### BEST MODE FOR CARRYING OUT THE INVENTION

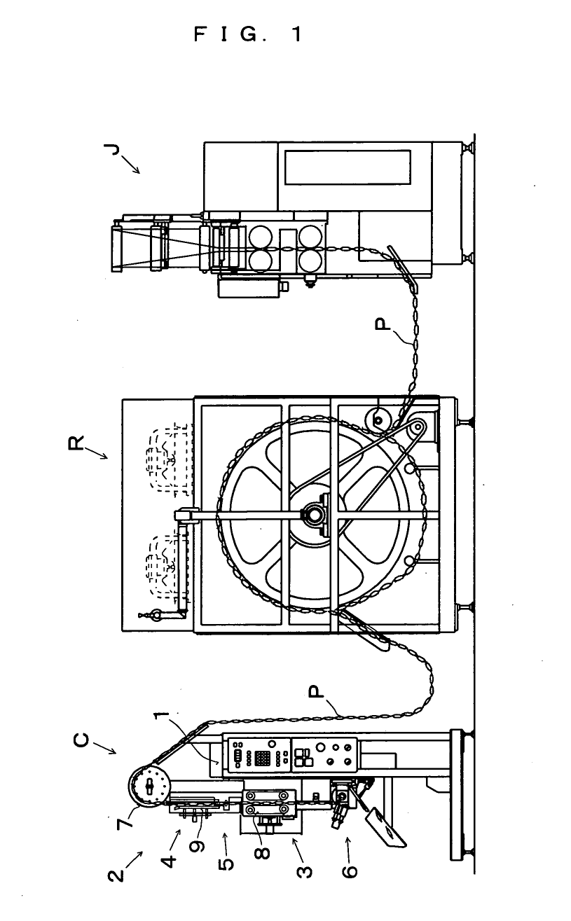

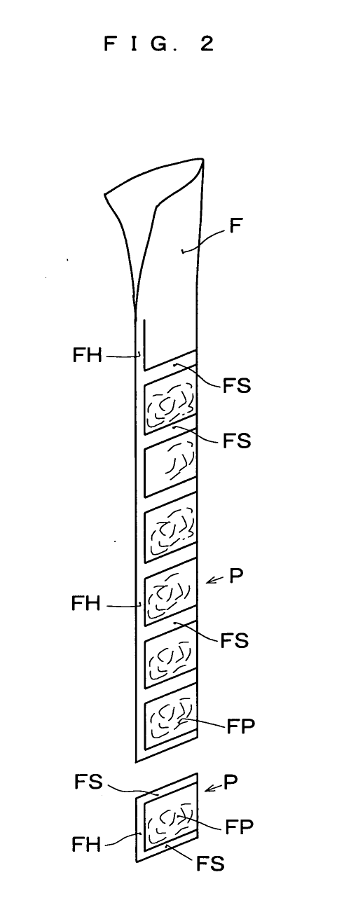

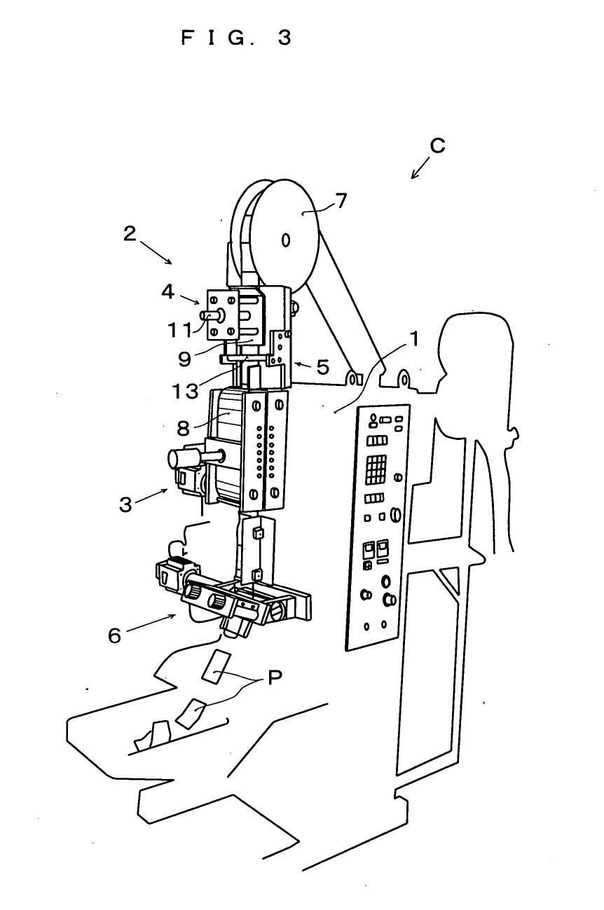

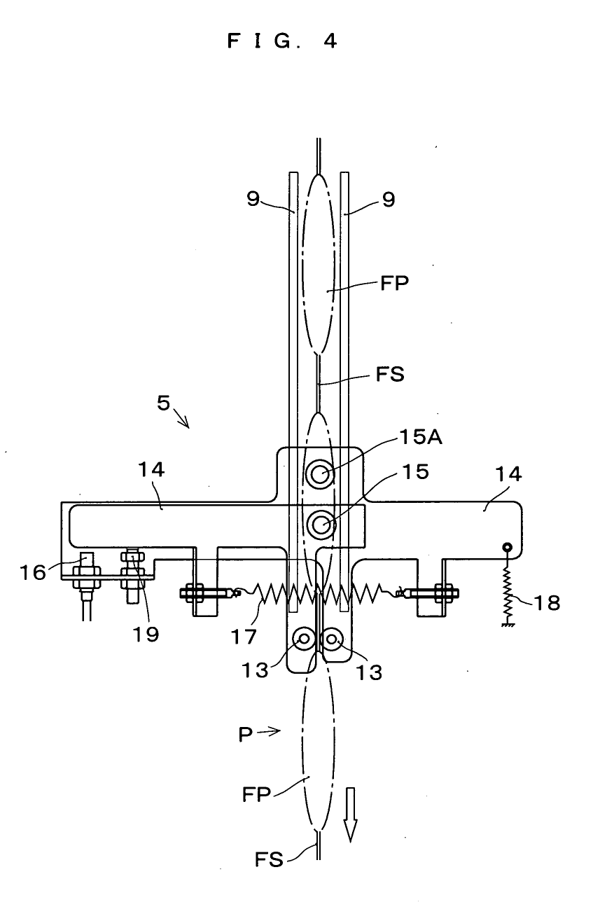

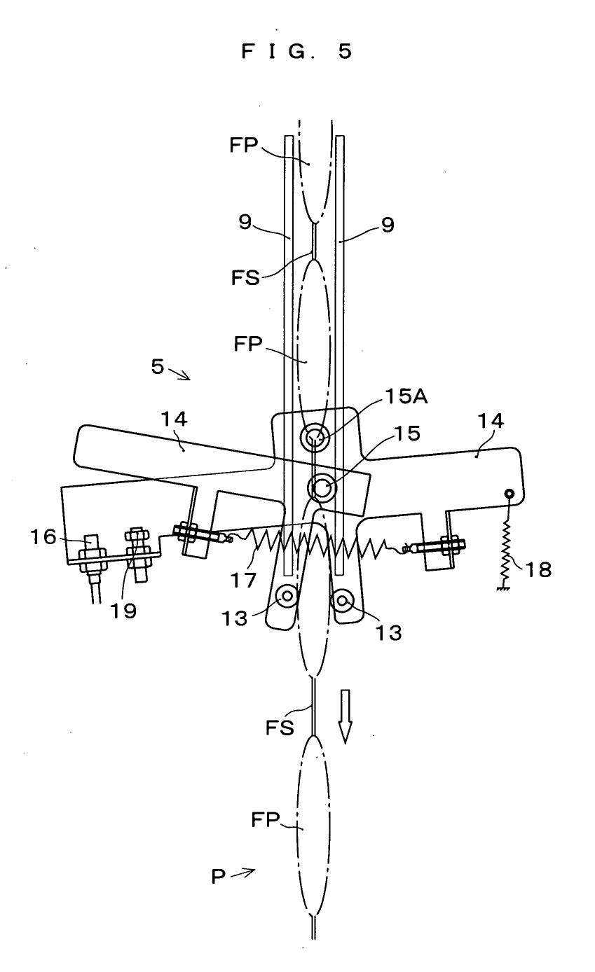

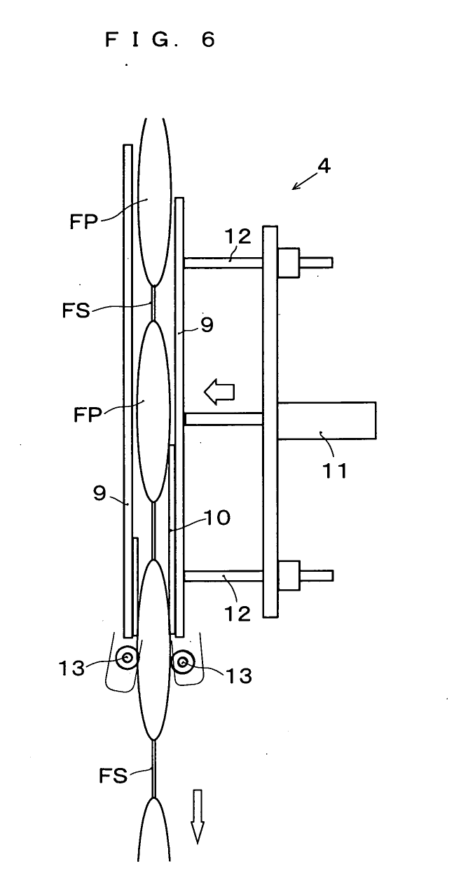

The invention will be hereinafter explained about embodiments thereof wherein a thickness detection device for a continuous belt-like filling and packaging bag according to the invention is applied to a cutting device. FIGS. 1 to 6 represent the first embodiment of the invention. When a high temperature liquid material such as a liquid or a viscous matter as a content is packaged as in a so-called “hot pack”, for example, the content is filled and packaged as a continuous belt-like filling and packaging bag P while being heated and sterilized, and the filling and packaging bag P so heated is supplied to and cooled by a cooling device R as a heat exchange treatment device. The continuous belt-like filling and packaging bag P cooled by the cooling device R is guided and supplied to a cutting device C.

In this case, a filling and packaging machine J applies fold portions formed by folding a belt-like film F continuously fed from the filling and packaging machine J while forming a bag, longitudinal seal portions FH formed by heat sealing the overlapping edges of the folded film F in a longitudinal direction and transverse seal portions FS heat sealed with predetermined gaps in a transverse direction with respect to the longitudinal seal portion FH to the continuous belt-like filling and packaging bag P and bag portions FP by filling a content into the film F defined by the longitudinal seal portion FH and the transverse seal portions FS. The bag portions FP continue in the longitudinal direction while being partitioned from one another by the transverse seal portions FS to form the continuous belt-like filling and packaging bag P.

The cutting device C is so disposed as to transfer the continuous belt-like filling and packaging bag P from the cooling device R as the preceding step from the upper side to the lower side of a main body frame 1. In this case, the thickness detection device 2 for the filling and packaging bag P that is mounted to the cutting device C includes a transfer mechanism 3 for transferring under the continuous state the filling and packaging bag P having the bag portions FP which are encompassed by the longitudinal seal portion FH and the transverse seal portions FS and into which the content is filled and stored, a guide and support mechanism 4 for guiding the filling and packaging bag P transferred by the transfer mechanism 3, capable of clamping and holding the bag portions FP of the filling and packaging bag P from both sides, and a thickness detection mechanism 5 capable of detecting the difference of thickness between the bag portion FP formed in the filling and packaging bag P and the transverse seal portions FS and disposed at a position adjacent to the guide and support mechanism 4. The cutting device C further includes a cutter mechanism 6 for cutting the center of the transverse seal portion FS on the basis of the signal detected by the thickness detection mechanism 5 and separating the continuous belt-like filling and packaging bag P into a single or a plurality of packaging bags P.

The transfer mechanism 3 described above is arranged in such a fashion that the continuous belt-like filling and packaging bag P delivered from the cooling device R as the preceding step can be supplied from the upper side to the lower side of the main body frame 1 and includes a rotary feed drum 7 disposed at an upper part of the main body frame 1 and a pair of endless delivery belts 8 for delivering the filling and packaging bag P, that face each other and are disposed at an upper part of the main body frame 1.

The guide and support mechanism 4 described above that guides the continuous belt-like filling and packaging bag P transferred by the transfer mechanism 3 and can clamp and support the bag portion FP of the filling and packaging bag P from both sides is disposed between the rotary feed drum 7 and the delivery belts 8. In this guide and support mechanism 4, sheet-like guide plates 9 are so disposed as to extend along both sides of the filling and packaging bag P in the direction of its thickness and push plates 10 having a predetermined width are disposed inside the guide plates 9 in such a fashion as to face each other. A cylinder 11 is interconnected to at least one of the guide plates 9. One of the guide plates 9 can reciprocate back and forth along guide rods 12 while facing the other guide plate 9. During the operation of the transfer mechanism 3, one of the guide plates 9 described above pushes the bag portion FP of the filling and packaging bag P by a predetermined push force towards the other guide plate 9 by the operation of the cylinder 11.

The thickness detection mechanism 5 capable of detecting the difference of thickness between the bag portion FP formed in the filling and packaging bag P and the transverse seal portion FS is disposed at a position adjacent to the guide and support mechanism 4. Detection elements 13 facing each other and capable of pushing and coming into mutual contact from both outer surface sides of the film F of the bag portion FP of the filling and packaging bag P is provided to the thickness detection mechanism 5. Rocking arm members 14 as support members for respectively supporting the detection elements 13 are disposed in such a fashion as to be capable of opening and closing with a support shaft 15 as a base point. In this first embodiment, a proximity sensor 16 as a detector for detecting displacement of the detection element 13 is arranged at a predetermined position of the end of an arm of one of the rocking arm members 14 and faces the end of the arm of the other rocking arm member 14 in the proximity of this end of the arm. An elastic member 17 such as a coil spring for enabling the detection elements 13 to push and come into contact with each other from both outer surface sides of the film F of the filling and packaging bag P is hooked between the rocking arm members 14 in the first embodiment. The elastic member 17 imparts tension so that the detection elements 13 can be always brought into contact with each other on the side of the filling and packaging bag P.

One of the rocking arm members 14 is disposed in such a fashion as to be capable of rocking with a second support shaft 15A disposed on the side of the main body frame 1 as the base point, and a second elastic member 18 such as a coil spring is interposed between the end of this rocking arm member 14 and the main body frame 1 so as to impart tension in a predetermined direction. Incidentally, in this first embodiment, one of the rocking arm members 14 as the support member is shaped substantially into a T shape while the other rocking arm member 14 is shaped substantially into an L shape. A stopper 19 is interposed between the end portions of the rocking arm members 14 on the protrusion side so as to set the gap between the detection elements 13. Consequently, when the filling and packaging bag P is interposed between the detection elements 13, the gap is set in consideration of the thickness of the film F and the load during transfer of the film F can be reduced. The gap can be set to a predetermined gap by bringing the proximity sensor 16 fitted to the end portion of one of the rocking arm members 14 and the arm end portion of the other rocking arm member 14 into a proximity state.

The operation of the thickness detection device for a filling and packaging bag according to the invention will be hereinafter explained. When the belt-like filling and packaging bag P accommodating the content such as a liquid or powder is transferred under the continuous state from the upper part to the lower part of the main body frame 1 by the transfer mechanism 3 including the rotary feed drum 7 arranged at the upper portion of the main body frame 1 of the cutting device C and the pair of endless delivery belts 8 facing each other and transferring the filling and packaging bag P while the bag P is clamped between them, the guide and support mechanism 4 capable of clamping and holding the bag portion FP of the filling and packaging bag P from both sides guides and transfers the filling and packaging bag P along the guide plates 9 and the filling and packaging bag P is transferred while its outer surface side is clamped by the push plates 10 arranged on the inner walls of the pair of guide plates 9 at a predetermined push force (predetermined push force by pneumatic control) due to the operation of the cylinder. Therefore, because the bag portion FP of the filling and packaging bag P is clamped and held at the predetermined push force (predetermined push force by pneumatic control), only the bag portion FP is stiff and tense even when pushed from outside. Incidentally, the guide and support mechanism 4 may be constituted in some cases by arranging merely the pair of guide plates 9 without disposing the push plates 10, and at least one of the guide plates 9 may be so arranged as to be capable of being adjusted and moving in conformity with the thickness of the bag portion FP of the filling and packaging bag P.

In this instance, in the first embodiment because the length of the push plates 10 arranged on the inner wall sides of the guide plates 9 is substantially equal to the gap (one pitch) between the transverse seal portions of the filling and packaging bag F, the bag portions FP of the filling and packaging bag P are transferred one after another while being clamped between the push plates 10 at the predetermined push force by the operation of the cylinder and are transferred and delivered. Because the detection elements 13 of the thickness detection mechanism 5 capable of detecting the difference in thickness between the bag portion FP formed in the filling and packaging bag P and the transverse seal portion FS is arranged at the position in the proximity of the guide and support mechanism 4, the filling and packaging bag P sent out from the positions of the push plates 10 is continuously transferred from above to below by the transfer mechanism 3. Then, the detection elements 13 open and close in accordance with the thickness of the bag portion FP of the filling and packaging bag P and the transverse seal portion FS with the movement by the transfer of the filling and packaging bag P while repeating the sliding motion. In this case, the detection elements 13 disposed on the rocking arm member 14 as the support member having the support shaft 15 as the base point rock and move under the state where they push and keep contact with both outer surfaces of the film F.

In other words, when the bag portion FP of the filling and packaging bag P passes by the positions of the detection elements 13, the detection elements 13 facing each other and keeping mutual contact from both surface sides of the film F of the bag portion FP of the filling and packaging bag P rock and move with the rocking arm members 14 as the support members along the outer diameter of the bag portion FP while being pushed outward against the force of the elastic members 17 with the support shaft 15 as the base point and the distance between the proximity sensor 16 as the detector fitted to the arm end portion of one of the rocking arm members 14 and the arm end portion of the other rocking arm member 14 changes with this movement. The proximity sensor 16 thus operates and outputs the detection signal, the cutter mechanism 6 of the cutting device C operates on the basis of this signal and cuts the center position of the transverse seal portions FS of the filling and packaging bag P connected in the continuous form, the film is divided into the individual bags and the bags are taken out. When the detection elements 13 reach the position of the transverse seal portion FS of the filling and packaging bag P after passing by the position of the bag portion FP of the filling and packaging bag P, the rocking arm members 14 as the support members that have been pushed outward against the force of the elastic members 17 return to the original positions with the support shaft 15 as the base point. Due to repetition of this operation, the passage of the filling and packaging bags P is detected one after another. In this instance, the detection elements 13 are provided to the rocking arm members 14 capable of rocking with the support shaft 15 as the base point in such a fashion as to face and push each other and to come into mutual contact from both surface sides of the film F of the bag portion FP of the filling and packaging bag P, and the detectors (proximity sensor) 16 for detecting the displacement of the detection elements 13 are disposed at the predetermined positions of the rocking arm members 14 in the thickness detection mechanism 5. Therefore, even when the packaging form for each kind of a product, particularly the thickness of the filling and packaging bag P, changes, the detection elements 13 facing and pushing each other from both surface sides of the film F of the bag portion FP of the filling and packaging bag P and coming into mutual contact are provided to the rocking arm members 14 as the support members with the support shaft 15 as the base point and consequently, the follow-up property is satisfactory and the detector 16 can operate under the steady condition without being affected by the change of the thickness of the bag portion FP of the filling and packaging bag P.

The filling and packaging bag P is transferred to the thickness detection mechanism 5 while the bag portion FP of the filling and packaging bag P is clamed at the predetermined push force (constant push force by pneumatic control). The detection elements 13 satisfactorily follow up the change of the thickness of the filling and packaging bag P. For this reason, the operation of the detector 16 becomes satisfactory, too, and the detection operation becomes possible more accurately than before and with high follow-up property even when the transfer speed becomes higher, irrespective of the amount of the content accommodated in the bag portion FP of the filling and packaging bag P. As the transfer speed becomes higher, rolling of the filling and packaging bag P is more likely to occur but in this first embodiment, each rocking arm member 14 as the support member is so arranged as to follow the movement (rolling) of the filling and packaging bag P with the second support shaft 15A as the base point. Consequently, detection accuracy can be improved without being affected by rolling and response can be kept at a high level.

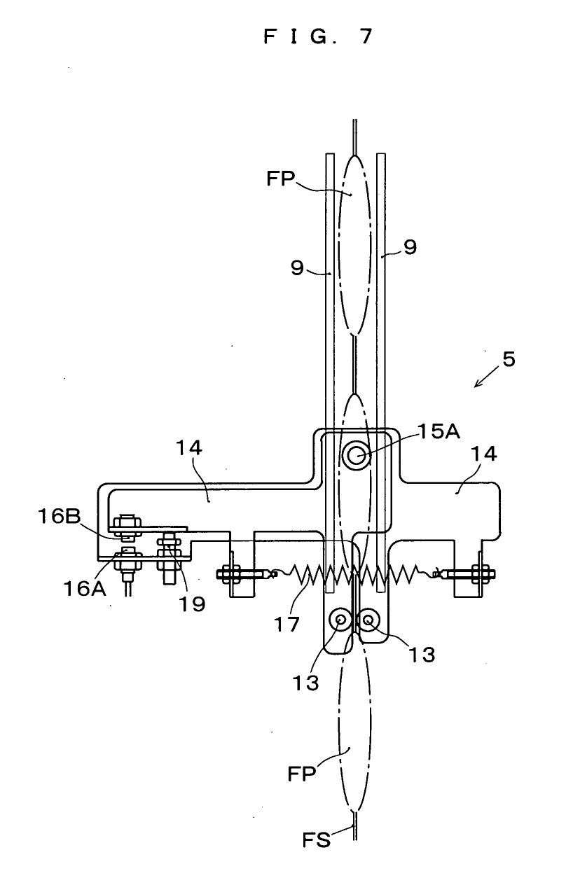

FIG. 7 shows the second embodiment of the invention. The thickness detection mechanism 5 for detecting the difference of thickness between the bag portion FP formed in the filling and packaging bag P and the transverse seal portion FS is arranged at the position in the proximity of the guide and support mechanism 4 in the same way as in the first embodiment. In this embodiment, the thickness detection mechanism 5 includes the detection elements 13 that face each other from both outer surface sides of the film F of the bag portion FP of the filling and packaging bag P and can push and come into contact with each other and the rocking arm members 14 as the support members for respectively supporting the detection elements 13 that can directly rock at the support shaft 15A fitted to the main body frame 1. A photo-sensor 16A as the detector for detecting displacement of the detection elements 13 is fitted to a predetermined position at the end portion of one of the arms and a photo-sensor 16B is arranged at the end portion of the arm of the other rocking arm member 14 as the support member in such a manner as to face the photo-sensor 16A.

The elastic member 17 such as a coil spring is spread between the rocking arm members 14 as the support members so that the detection elements 13 can face from both outer surface sides of the film F of the filling and packaging bag P and can push and come into contact with each other. The elastic member 17 applies the tension so that each detection element 13 can always keep contact with the filling and packaging bag P and can follow rolling of the filling and packaging bag P through the support member 14 with the support shaft 15A as the base point.

Therefore, almost same with the first embodiment, even when the packaging form for each kind of the product, particularly the thickness of the filling and packaging bag P, changes, follow-up performance is excellent in substantially the same way as in the first embodiment because the detection elements 13 facing each other from both surface sides of the film F of the bag portion FP of the filling and packaging bag P and capable of pushing and coming into contact with each other are provided to the rocking arm members 14A as the support members with the support shaft 15A as the base point. Consequently, the detectors constituted as the photo-sensors 16A and 16B can be operated under the stable state without being affected by the change of the thickness of the bag portion FP of the filling and packing bag P. Because each rocking arm member 14 as the support member is so arranged as to follow the movement (rolling) of the filling and packaging bag P and to rock with the support shaft 15A as the base point, detection accuracy can be improved much more than in the prior art without being affected by rolling and response can be kept at a high level, too.

The invention is not limited to the embodiments described above but can be changed or modified in various ways within the scope of the invention. The shape of the detection elements 13 of the thickness detection mechanism 5 and the shape of the support members 14 can be changed appropriately. In each of the embodiments, the detection elements 13 are constituted in such a fashion as to face each other from both outer surface sides of the film F of the filing and packaging bag P and to be capable of pushing and coming into contact with each other through the support members 14 with the support shaft 15 as the base point. However, the same effect can be obtained by arranging the support members supporting the detection elements 13 in such a fashion as to be capable of sliding in the direction of thickness of the filling and packaging bag P and following up the movement (rolling) of the continuous filling and packaging bag.

Each embodiment uses the coil spring as the elastic member 17 interposed between the support members 14 (rocking arm members) of the thickness detection mechanism 5, for causing the detection elements 13 to face each other from both outer surface sides of the film F of the filling and packaging bag P and to push and come into contact with each other. However, the elastic member 17 may be a leaf spring or a rubber spring. The detector 16 is not limited to the magnetic proximity sensor but may be a photo sensor or a limit switch. Alternatively, it is possible to dispose a load sensor to detect the load on the detection elements 13 and to discriminate the thickness of the bag portion FP and the transverse seal portion FS from the difference of the load.

As described above in detail, the thickness detection device for the filling and packaging bag according to the invention includes the transfer mechanism for transferring the filling and packaging bag having bag portions formed by filling and accommodating the content into the film encompassed by the longitudinal seal portion and the transverse seal portions under the continuous state; and the thickness detection mechanism capable of detecting the difference in thickness between the bag portion formed in the continuous filling and packaging bag and the transverse seal portion; the thickness detection mechanism including detection elements capable of following rocking of the filling and packaging bag in the transverse direction with respect to the feeding direction of the continuous filling and packaging bag, facing each other from both outer surface sides of the film of the filling and packaging bag and capable of pushing, and coming into contact with, each other, and the detector for detecting displacement of the detection elements resulting from the difference in thickness of the bag portion and the transverse seal portion of the filling and packaging bag. Therefore, even when the packaging form for each kind of the product, particularly the thickness of the filling and packaging bag, changes, follow-up performance against rolling of the filling and packaging bag becomes excellent and the detector can be operated under the stable state without being affected by the change of the thickness of the bag portion of the filling and packaging bag.

According to the invention, the thickness detection device for the filling and packaging bag includes the transfer mechanism for transferring the filling and packaging bag having bag portions formed by filling and accommodating the content into the film encompassed by the longitudinal seal portion and transverse seal portions under the continuous state; and the thickness detection mechanism capable of detecting the difference in thickness between the bag portion formed in the continuous filling and packaging bag and the transverse seal portion; the thickness detection mechanism including the detection elements facing each other from both outer surface sides of the film of the filling and packaging bag and capable of pushing, and coming into contact with, each other, support members for respectively supporting the detection elements in such a fashion as to be capable of rocking with the support shaft as the base point, and the detector for detecting displacement of the detection elements arranged at the predetermined positions of the support members. Therefore, even when the packaging form for each kind of the product, particularly the thickness of the filling and packaging bag, changes, follow-up performance against rolling of the filling and packaging bag becomes excellent and the detector can be operated under the stable state without being affected by the change of the thickness of the bag portion of the filling and packaging bag because the detection elements facing each other from both outer surface sides of the film of the bag portion and the transverse seal portion of the filling and packaging bag and capable of pushing, and coming into contact with, each other, are provided to the support members with the support shaft as the base point.

In this case, the elastic member is interposed between the support members of the thickness detection mechanism so that the support members face each other from both outer surface sides of the film of the filling and packaging bag and can push, and come into contact with, each other. Therefore, the detection elements are so arranged as to push the bag portion of the filling and packaging bag from both outer surface sides of the film by means of the tension of the elastic member and follows in accordance with the difference in thickness of the swell portion of the bag portion and the reduced thickness portion of the transverse seal portion. Therefore, even when the transferring rate of transferring the filling and packaging bag under the continuous state is high, the response becomes higher than before and detection accuracy can be increased.

Because the guide and support mechanism for guiding the filling and packaging bag transferred by the transfer mechanism, capable of clamping and holding the bag portion of the filling and packaging bag from both sides is disposed adjacent to the thickness detection mechanism, the guide and support mechanism can clamp and hold from both sides the bag portion of the filling and packaging bag even when the detection elements facing each other from both outer surface sides of the film of the filling and packaging bag and capable of pushing, and coming into contact with, each other push the bag portion of the filling and packaging bag. Even when the content is the liquid, the detection elements can detect the bag portion under the solid and swell condition and the change in thickness between the position of the bag portion and the position of the transverse seal can be clearly detected. Consequently, detection accuracy can be further improved.

### INDUSTRIAL APPLICABILITY

In the invention, the thickness detection device for the filling and packaging bag is applied as the detection portion for indexing the cutting position of the cutter mechanism for cutting the filling and packaging bag P. However, this thickness detection device can be applied as a thickness detection device that discriminates the change in thickness between the bag portion FP and the transverse portion FS of the filling and packaging bag P, counts the discrimination signals and the number of the filing and packaging bags P, for example.

1. A thickness detection device for a filling and packaging bag characterized by including:
a transfer mechanism for transferring a filling and packaging bag having bag portions formed by filling and accommodating a content into a film encompassed by a longitudinal seal portion and transverse seal portions under a continuous state; and
a thickness detection mechanism capable of detecting a difference in thickness between the bag portion and the transverse seal portion formed in the continuous filling and packaging bag;
the thickness detection mechanism including detection elements capable of following rocking of the filling and packaging bag in a transverse direction with respect to a feeding direction of the continuous filling and packaging bag, facing each other from both outer surface sides of the film of the filling and packaging bag and capable of pushing, and coming into contact with, each other, and a detector for detecting displacement of the detection elements resulting from the difference in thickness of the bag portion and the transverse seal portion of the filling and packaging bag.

2. A thickness detection device of a filling and packaging bag according to claim 1, characterized by including a guide and support mechanism for guiding the filing and packaging bag transferred by the transfer mechanism and capable of clamping and holding the bag portion of the filling and packaging bag from both sides.

3. A thickness detection device of a filling and packaging bag according to claim 2, wherein the guide and support mechanism is arranged in the proximity of the thickness detection mechanism.

4. A thickness detection device for a filling and packaging bag characterized by including:
a transfer mechanism for transferring a filling and packaging bag having bag portions formed by filling and accommodating a content into a film encompassed by a longitudinal seal portion and transverse seal portions under a continuous state; and
a thickness detection mechanism capable of detecting a difference in thickness between the bag portion and the transverse seal portion formed in the continuous filling and packaging bag;
the thickness detection mechanism including detection elements facing each other from both outer surface sides of the film of the filling and packaging bag and capable of pushing, and coming into contact with, each other, support members for respectively supporting the detection elements in such a fashion as to be capable of rocking with a support shaft as a base point, and a detector for detecting displacement of the detection elements arranged at a predetermined position of the support members.

5. A thickness detection device for a filling and packaging bag according to claim 4, wherein an elastic member is interposed between the support members of the thickness detection mechanism so that the detection elements face each other from both outer surface sides of the film of the filling and packaging bag and can push, and come into contact with, each other.

6. A thickness detection device for a filling and packaging bag according to claim 4 or 5, which further includes a guide and support mechanism for guiding the filling and packaging bag transferred by the transfer mechanism, capable of clamping and holding the bag portion of the filling and packaging bag from both sides.

7. A thickness detection device for a filling and packaging bag according to claim 6, wherein the guide and support mechanism is arranged adjacent to the thickness detection mechanism.
